(19) United States
(12) Patent Application Publication
(10) Pub. No.: US 2008/0047940 A1
(43) Pub. Date: Feb. 28, 2008

(54) Article with multiple surface depressions and method for making the same

(76) Inventors: Xinghua Li, Horseheads, NY (US); Mark Lawrence Powley, Campbell, NY (US); Robert Stephen Wagner, Corning, NY (US)

Correspondence Address: CORNING INCORPORATED, SP-TI-3-1, CORNING, NY, 14831, US

(21) Appl. No.: 11/820,514

(22) Filed: Jun. 20, 2007

Related U.S. Application Data
(60) Provisional application No. 60/840,567, filed on Aug. 28, 2006.

(51) Int. Cl. B23K 26/00

(52) U.S. Cl. 219/121.68; 428/338

(57) ABSTRACT

Articles having multiple surface depressions and process and apparatus for making the same. The invention is useful in making, inter alia, glass plates having a surface depression array which can be used in semiconductor and electronics manufacture, drug discovery and display devices.

### CROSS-REFERENCE TO RELATED APPLICATION

The present application claims priority to U.S. Provisional Patent Application Ser. No. 60/840567, filed on Aug. 28, 2006, entitled “ARTICLE WITH MULTIPLE SURFACE DEPRESSIONS AND METHOD AND SYSTEM FOR MAKING THE SAME,” the content of which is relied upon and incorporated herein by reference in its entirety.

### FIELD OF THE INVENTION

The present invention relates to articles having a plurality of surface depressions, and method as well as apparatus for making the same. In particular, the present invention relates to articles such as glass plates having micro depression arrays, laser ablation process for making the same and apparatus for making the same involving laser ablation.

### BACKGROUND OF THE INVENTION

Articles having a surface with arrays of depressions are widely used in various industries, ranging from information display, drug discovery, microlithography, to printing and others. The depressions may form two-dimensional arrays with various patterns in which various materials can be placed, processed or further disposed of.

Fabrication of articles with surfaces having relatively large depressions on the centimeter and millimeter scale can be done by, e.g., carving, pressing, molding, mechanical drilling, and the like. However, when the dimensions of such depressions are required to be on the micron meter scale, ranging from several micrometer to several hundred of micrometers, those methods usually cannot be effectively utilized, especially where a large array of depressions are required to have essentially uniform sizes and to be precisely aligned to each other. This is especially true with regard to creating depression arrays on hard materials that require high processing temperatures, such as inorganic glass and glass-ceramic materials. Moreover, mechanical machining typically would result in poor surface quality of the depressions. Where low surface roughness of the depressions is desired, further surface finishing step such as etching may be required.

In an effort to fabricate articles with surface depression arrays on the micrometer scale based on inorganic glass, lithographic processes may be used. As in the semiconductor industry, the surface is covered with a layer of photoresist film, then selectively exposed to lithographic irradiation, followed by etch, resist stripping and cleaning, whereby a plurality of etched depressions can be formed on the surface. This method is effective in creating depressions that form a predetermined pattern on the surface, and the outer diameter of the depression can be relatively precisely controlled.

However, the lithographic approach suffers from the following drawbacks. First of all, the etching process typically requires the use of etching solutions specific to the substrate material. For example, for SiO₂-containing inorganic glass, HF.NH₄F solution is a typically used etching solution. Waste disposal in such etching process is a significant challenge. Moreover, the lithographic process requires multiple steps including resist applications, etch, resist stripping, and complex equipment such as the lithographic tools, thus is inherently costly.

Still another problem of the lithographic approach is the lack of ability to produce certain shape of the depressions. Generally, when a piece of glass is etched, especially where wet etch is used (which is what is used in most cases), the material is removed non-discriminatively in all directions of the surface in contact with the etching solution (i.e., isotropic etch). As is known in the art of lithography, this typically results in undercutting of the substrate under the film on the top of the substrate. Such undercutting is usually highly undesirable if the film (such as a layer of metal) is desired to be retained on the top of the substrate surface. In cases where the film is not to be retained (such as where the film is a layer of photoresist), the end result would be a depression with outer diameter larger than that of the exposed area, and an outer diameter to depth ratio of higher than 2:1. It is difficult, therefore, to obtain depressions with smaller outer diameter to depth ratio. This means that, where the desired outer diameter of the depression is pre-determined, it would be difficult to obtain depressions with larger cavity volume. Due to the inflexibility of the outer diameter to depth ratio of the wet etch process, it would be difficult to create depressions with a wide range of outer diameter to depth ratios.

Yet another drawback of the lithography approach is the need of creating a mask prior to lithography, which is usually a costly extra step. Image of depression patterns are first recorded into a precision mask, which is then used as the source of the depression pattern information to be formed on the article surface. While for large volume production the cost of the mask can be shared and mitigated among the many products, for relatively small-scale production, the cost of the mask can lead to prohibitively high final cost for the final product, and the formation of the mask can delay the production of the final product as well.

Therefore, there remains a genuine need of a process for making articles having a surface bearing a plurality of depressions without the drawbacks of the methods described above. There is also a genuine need of articles having a surface bearing a plurality of depressions having high surface quality yet dimensions typically not obtainable by wet etch.

### SUMMARY OF THE INVENTION

Accordingly, a first aspect of the present invention is an article having a surface bearing a plurality of depressions having an outer diameter of not larger than 500 μm and an outer diameter to depth ratio of smaller than 2. In certain embodiments of the article of the first aspect of the present invention, the depressions have a fire-polished surface.

A second aspect of the present invention relates to an article having a surface bearing a plurality of depressions having an outer diameter of not larger than 500 μm, wherein the depressions have fire-polished surface. In certain embodiments of the article of the second aspect of the present invention, the depressions have an outer diameter to depth ratio of smaller than 2.

In certain embodiments of the article of the first and/or second aspects of the present invention, the depressions have an outer diameter to depth ratio smaller than 2, in certain embodiments smaller than 1.5, in certain other embodiments smaller than 1.0, in certain other embodiments smaller than 0.8, in certain other embodiments smaller than 0.5.

In certain embodiments of the article of the first and/or second aspect of the present invention, the diameter of the cross-section of each individual depression essentially normal to the direction of the depth thereof decreases in the direction from the article surface to the bottom of the depression.

According to certain embodiments of the article of the first and/or second aspects of the present invention, the outer diameter to depth ratios of the depressions vary. In certain embodiments, they may vary from 3.0 to 0.5.

According to certain embodiments of the article of the first and/or second aspects of the present invention, the depressions form at least one array.

According to certain embodiments of the article of the first and/or second aspects of the present invention, the depressions have a surface roughness of less than 5 nm, in certain embodiments less than 1 nm, in certain embodiments less than 0.5 nm, in certain embodiments less than 0.1 nm.

According to certain embodiments of the article of the first and/or second aspects of the present invention, the depressions are formed by directing a laser beam to the surface area where a depression is desired.

According to certain embodiments of the article of the first and/or second aspects of the present invention, the article is a plate having at least one major surface, and wherein the depressions are formed on at least one major surface.

According to certain embodiments of the article of the first and/or second aspects of the present invention, the article is made of inorganic glass, glass-ceramic or crystalline materials.

According to certain embodiments of the article of the first and/or second aspects of the present invention, at least the material forming the surface bearing the depressions has a melting point of not lower than 500° C., in certain embodiments not lower than 800° C., in certain other embodiments not lower than 1000° C., in certain embodiments higher than 1200° C., in certain embodiments higher than 1500° C. In certain embodiments, the surface material is a glass or glass-ceramic comprising at least 80% by weight of silica, in certain embodiments at least 90%, in certain embodiments at least 95%. In certain embodiments of the article of the first and/or second aspects the surface region is made of silica.

According to certain embodiments of the article of the first and/or second aspects of the present invention, the depressions have a standard deviation of outer diameter not higher than 5 μm, in certain embodiments not higher than 3 μm, in certain other embodiments not higher than 1 μm, in certain embodiments not higher than 0.5 μm.

According to certain embodiments of the article of the first and/or second aspects of the present invention, the depressions have a standard deviation of depth of not larger than 5%, in certain embodiments not larger than 3%, in certain embodiments not larger than 1%, of the average depth of the depressions.

According to certain embodiments of the article of the first and/or second aspects of the present invention, the depressions have an essentially uniform diameter in the direction of the depth from the article surface to the bottom of the depressions.

According to certain embodiments of the article of the first and/or second aspects of the present invention, the depressions form an array having a plurality of rows and columns, and the spacing between the rows or columns is not larger than 2 times of the average outer diameters of the depressions. In certain embodiments, the spacing between the rows and the columns is not larger than 2 times of the average outer diameter of the depressions. In certain embodiments, the spacing between the rows or the columns is essentially uniform.

According to certain embodiments of the article of the first and/or second aspects of the present invention, at least the surface region of which is made of a material having a coefficient of thermal expansion from 0 to 300° C. in the range of 0-40×10⁻⁷/° C., in certain embodiments in the range of 0-30×10⁻⁷/° C., in certain embodiments in the range of 0-15×10⁻⁷/° C., in certain other embodiments in the range of 0-8×10⁻⁷/° C., in certain other embodiments in the range of 1-4×10⁻⁷/° C.

A third aspect of the present invention is directed to a process for making an article having a surface bearing a plurality of depressions, comprising the following steps:

(A) directing a laser beam to the surface area where a depression is desired;

(B) allowing the laser beam to ablate the material in surface area which is exposed to the laser beam, such that a plurality of depressions having an outer diameter not larger than 500 μm is formed.

According to certain embodiments of the process of the present invention, where thermal ablation is involved, the depression formed in step (B) has fire-polished surface.

According to certain embodiments of the process of the present invention, in step (B), the time of ablation is sufficiently long such that at least part of the depressions formed have an outer diameter to depth ratio of lower than 2, in certain embodiments lower than 1.5, in certain embodiments lower than 1, in certain embodiments lower than 0.8, in certain other embodiments lower than 0.5.

According to certain embodiments of the process of the present invention, the depressions are formed by a single laser beam repeatedly at differing locations. In certain other embodiments, the depressions are formed by a plurality of laser beams operating at least partially simultaneously.

According to certain embodiments of the process of the present invention, the depressions formed in step (B) have a surface roughness of less than 5 nm, in certain embodiments less than 1 nm, in certain embodiments less than 0.5 nm, in certain embodiments less than 0.1 nm.

According to certain embodiments of the process of the present invention, the article is a plate having at least one major surface, and wherein the depressions are formed on at least one major surface.

According to certain embodiments of the process of the present invention, the article is made of inorganic glass, glass-ceramic or crystalline materials.

According to certain embodiments of the process of the present invention, the surface to be ablated of the article is made of a material having a melting point of not lower than 500° C., in certain embodiments now lower than 800° C., in certain embodiments not lower than 1000° C., in certain embodiments not lower than 1200° C., in certain embodiments not lower than 1500° C., and the ablated surface area is heated to a temperature higher than the melting point of the material at least partly by the laser beam.

According to certain embodiments of the process of the present invention, the depressions formed in step (B) have a standard deviation of outer diameter not higher than 5 μm, in certain embodiments not higher than 3 μm, in certain other embodiments not higher than 1 μm, in certain embodiments not higher than 0.5 μm.

According to certain embodiments of the process of the present invention, the depressions have a standard deviation of depth of not larger than 5%, in certain embodiments not larger than 3%, in certain embodiments not larger than 1%, of the average depth of the depressions.

According to certain embodiments of the process of the present invention, the diameter of the cross-section of individual depression essentially normal to the direction of the depth thereof decreases in the direction of the depth from the article surface to the bottoms of the depressions.

According to certain embodiments of the process of the present invention, the depressions created in step (B) form at least one array, and the spacing between the rows or columns are not larger than 2 times of the average outer diameters of the depressions. According to certain embodiments of the process of the present invention, the spacing between the rows and the columns are not larger than 2 times of the average outer diameter of depressions. According to certain embodiments of the process of the present invention, the spacing between the rows and columns are essentially uniform.

According to certain embodiments of the process of the present invention, at least the surface region of the article to be ablated is made of a material having a coefficient of thermal expansion from 0 to 300° C. in the range of 0-40×10⁻⁷/° C., in certain embodiments in the range of 0-30×10⁻⁷/° C., in certain embodiments in the range of 0-15×10⁻⁷/° C., in certain other embodiments in the range of 0-8×10⁻⁷/° C., in certain other embodiments in the range of 1-4×10⁻⁷/° C.

According to certain embodiments of the process of the present invention, the laser is selected from the group consisting of: CO₂ laser, YAG laser, UV excimer laser.

According to certain embodiments of the process of the present invention, the surface area directly exposed to the laser beam has a diameter of less than 200 μm, in certain embodiments less than 150 μm, in certain embodiments less than 100 μm, in certain embodiments less than 50 μm.

A fourth aspect of the present invention is a system for forming a plurality of depressions on a surface of an article, comprising the following components:

(i) a laser generator;

(ii) a laser focusing device capable of providing a laser beam directed to the surface of the article on which the depressions are to be formed;

(iii) a stage on which the article is to be placed for laser ablation; and

(iv) a device capable of moving the laser beam relative to the surface of the article to be ablated.

Certain embodiments of the present invention have one or more of the following advantages. First, the articles of the present invention can have depressions with various geometry and dimensions achievable by laser ablation, particularly with various outer diameter to depth ratios. Especially, the depressions can have an outer diameter to depth ratio of smaller than 2, which is difficult to achieve in the traditional lithographic process. Yet, the depressions of the article of the present invention can have a very low surface roughness, which is desired in many applications. The article of the present invention can be based on various materials, including plastic, inorganic glass, glass-ceramic materials, and crystalline materials, depending on the end application. Second, as to the process and apparatus system of the present invention, they have the flexibility to be applicable for substrates made of various materials ranging from organic polymers, inorganic glass materials, glass-ceramic materials and crystalline materials; they can be used to produce depressions with various outer diameter to depth ratio; they can be used to produce various overall depression patterns on the surface of the article to be ablated; and they can be realized by using relatively inexpensive commercial laser generators such as CO₂ lasers.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings:

FIG. 1 is a schematic illustration of the cross-section of a glass plate bearing depressions formed by wet etch;

FIG. 2 is a schematic illustration of the cross-section of a glass plate bearing conical depressions according to an embodiment of the present invention;

FIG. 3 is a schematic illustration of the cross-section of a glass plate bearing truncated-conical depressions according to another embodiment of the present invention;

FIG. 4 is a partial picture of the surface of a glass plate bearing depressions formed by the laser ablation process of the present invention;

FIG. 5 is a schematic illustration of the apparatus set-up of one embodiment of the present invention;

FIG. 6 is an illustration of the typical pulse train of a CO₂ laser used in the examples of the present application;

FIG. 7 is a schematic illustration of the apparatus set-up of another embodiment of the present invention; and

FIG. 8 is a schematic illustration of the apparatus set-up of another embodiment of the present invention.

### DETAILED DESCRIPTION OF THE INVENTION

Unless otherwise indicated, all numbers such as those expressing weight percents of ingredients, dimensions, and values for certain physical properties used in the specification and claims are to be understood as being modified in all instances by the term “about.” It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, in describing and claiming the present invention, the use of the indefinite article “a” or “an” means “at least one,” and should not be limited to “only one” unless explicitly indicated to the contrary. Thus, for example, reference to “adepression” includes embodiments having two or more depressions, unless the context clearly indicates otherwise.

“Melting point” as used herein denotes the melting point under atmospheric pressure of a crystalline material, or softening point of a glass material, as the case may be.

As used herein, “depression surface” or “surface of a depression” means the wall surface of the depression.

As used herein, “glass consisting essentially of silica” means a glass material comprising, by weight, of at least 80% of silica.

As mentioned supra, articles having a surface bearing a plurality of depressions are used widely in various industries. While mechanical approaches and in situ formation of the depressions during the formation of the articles per se can be used for articles with a small number of relatively large depressions, they become economically non-viable when a large number of small depressions are required. Such small depressions are sometimes called cavities on the article surface.

Depending on the end use of the article bearing depressions, the depressions may be required to take various geometry and dimension, and may be required to have various degree of precision alignment. The depression, when intersected by a plane tangential to the surface on which the specific depression is formed, shows a cross-section thereof in the form of a closed curve. As used herein, the longest straight-line distance between any two points in this cross-section is the outer diameter of the depression. The length of a straight line segment from the lowest point of the depression to the plane tangential to the surface of the article, perpendicular to the plane tangential to the surface of the article, is regarded as the depth of the depression. The direction normal to the plane tangential to the surface of the article is called the direction of depth of depression. Thus, if the depression is a cylindrical cavity formed under a flat surface, the cross-section of the depression when intercepted by the surface plane would be a circle, and the outer diameter of the depression would be the diameter of the cylindrical surface of the depression. For another example, where the depression is an elongated cube formed under a flat surface, the cross-section of the depression when intercepted by the surface plane would be a rectangle, and the outer diameter of the depression would be the length of the diagonal line of the rectangular cross-section.

A plurality of depressions may form multiple rows and columns, forming a complex matrix, which is sometimes called “microcavity array.” The depressions in a micro-cavity array may be required to have an outer diameter ranging from 1 μm to 500 μm for various products. The arrays of depressions may form various patterns as well depending on the final use of the articles. For example, in the area of printing, pigments and/or dye solutions may be dispensed into the cavity array, and subsequently transferred onto the surface of the receiving media, such as paper, boards, fabric, and the like, to effect the printing of an image. For another example, dozens, hundreds and sometimes thousands of depressions in the cavity array may be filled with a certain fluid containing an antibody first, which is subsequently filled with samples of fluid to be tested. The differing reaction results in the large number of depressions can be revealed by various means, then collected and analyzed.

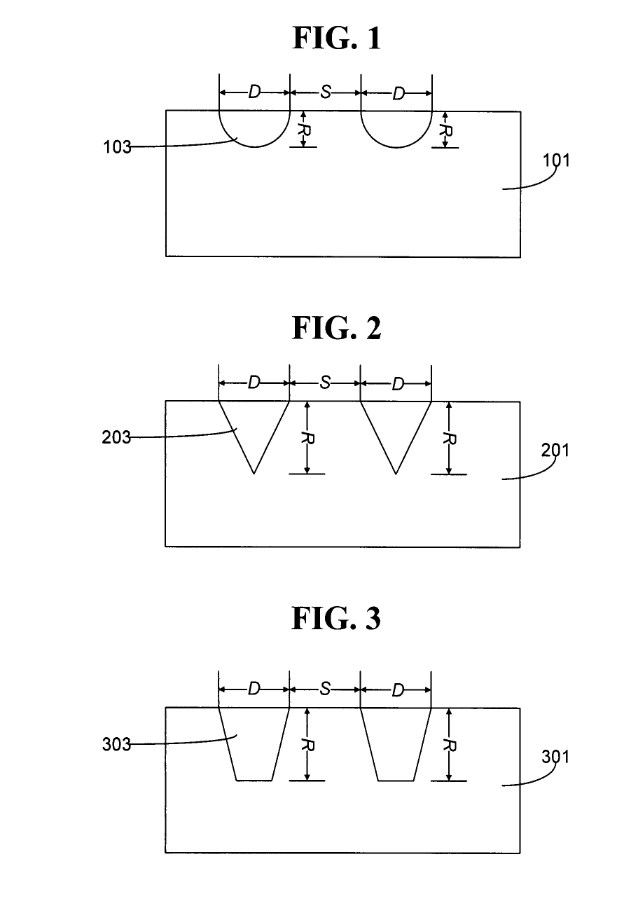

A natural solution for making the micro-cavity arrays on the surface of an article is lithography, which is currently used in relation to glass, glass-ceramic and ceramic based substrates. Lithography processes used typically requires wet etch by chemical solutions, as mentioned supra. With amorphous glass, glass-ceramic and ceramic substrates, the etching process is sometimes a multi-step undertaking and difficult to control in order to produce large variations in cavity volume. In addition, as mentioned supra, in isotropic etching processes (which are mostly the actual etching cases) of a flat substrate, the depressions eventually formed would usually take a semi-spherical or semi-ellipsoidal shape. FIG. 1 shows the cross-section of a typical depression formed by lithography. In this figure, 101 is a substrate in which semi-spherical surface depressions 103 are formed. The depressions have an outer diameter D and a depth R where D≧2R. In situations where D is pre-determined, the depth of the depression is limited to less than ½D, hence the volume of the depression is generally limited to less than 0.125π·D³. This is not desirable in many applications which would require deeper depression and larger volume thereof.

In certain applications, it is highly desired that the depressions have a conical shape or truncated conical shape, i.e., along the direction of the depth of the depression, from the surface of the article to the bottom of the depression, the area of the cross-sections obtained by intercepting the depression with planes parallel to a plane tangential to the article surface gradually decrease. FIG. 2 illustrates the cross-sectional view of a plate substrate 201 having cone-shaped depressions 203 with an outer diameter of D and a depth R. FIG. 3 illustrates the cross-sectional view of a plate substrate 301 having truncated cone-shaped depressions 303 with an outer diameter of D and a depth of R. In lithography process involving isotropic etch, the depressions illustrated in FIGS. 2 and 3 are difficult to obtain. As discussed above, if D<2R is required, the lithography approach with isotropic etch, alone, cannot be used to achieve these results. The edge (i.e., the area where the depression wall meets the main surface of the substrate on which the depressions are formed) of the depressions as illustrated in FIGS. 2 and 3 is angular. In practice, such edge can be rounded due to the melting and flowing of the material in that area.

The present inventors have found that, by employing laser ablation, depressions with geometry and dimensions unachievable by lithography can be produced. The depressions illustrated in FIGS. 2 and 3 can be made by using the process of the present invention.

Laser ablation is a process in which a material or an article is exposed to laser irradiation, thereby the material exposed is ablated and removed. Laser ablation can take place via non-thermal (such as chemical) or thermal mechanisms, or both. If the photon energy of the laser irradiation is higher than the band gap of the solid material, absorption thereof can cause ablation of the material without the need of heating it to a very high temperature. In thermal ablation, the material exposed to the laser irradiation is heated to such a high temperature, typically in a very short period of time, e.g., on the order of μs or even ns, upon absorption of the laser energy, evaporates and is removed from the bulk of the material. Evaporation in thermal ablation may take place due to physical changes, such as liquid to gas phase change (e.g., boiling), solid to gas phase change (sublimation), or due to thermal chemical effect, such as dissociation, disintegration of the material due to the high temperature, and the like. If silica is heated by a high-power laser beam to an extremely high temperature, e.g., higher than 2500° C., the following can take place simultaneously:

SiO₂ (s)→SiO₂ (g)

SiO₂ (s)→SiO (g)+½O₂ (g)

SiO₂ (g)→SiO (g)+½O₂ (g)

With removal of the material of the surface region, a depression is formed in the exposed area. In order to obtain laser ablation, especially of stable materials such as SiO₂, high-power laser focused to a small exposure area is used in certain embodiments to heat the material to the desired temperature where ablation can effectively occur. Indeed, in certain embodiments, high-power laser focused to an extremely small area is required in order to obtain a desired geometry of the depression, as detailed infra.

The present invention will be illustrated by laser ablating an inorganic glass material, such as silica glass, to form an article with an array of surface depressions. It is to be noted that, however, the present invention is applicable to other materials, such as organic polymer materials, organic-inorganic composite materials, inorganic glass-ceramic materials and inorganic crystalline materials. A general principle for effective laser ablation is that the solid material should absorb the laser irradiation in order to cause either the thermal and/or non-thermal effect desired that causes the vaporization of the material. This is particularly true for thermally ablating material having a very high softening, boiling or sublimation temperature. For example, it is understood by the present inventors that in order to successfully ablate articles made by SiO₂ glass, the transient temperature of the exposed area should desirably reach as high as 2000° C. in certain embodiments. In order to obtain certain desired geometry of the depressions, the ablation is desired to occur and terminated in a very short period of time. Thus high-power laser beam highly-absorptive to silica glass is desirably used. In the light of the teachings of the present application, one of ordinary skill in the art can choose the proper laser source and dosage, to make use of the present invention in connection with those various types of materials.

For typical inorganic glass and glass-ceramic materials, high-power lasers having a long wavelength, such as CO₂ laser (λ≈10.6 μm) can be used. SiO₂ glass network is absorptive of infrared at this wavelength due to the intrinsic network chain movement. Potential glass materials that could be used for laser ablation include, but are not limited to: soda lime glass; alumino-silicate glass; borosilicate glass such as Pyrex®; glasses having a high content of SiO₂, such as those comprising at least 80% by weight of silica, such as Vycor® glass (Corning glass code 7913™ made by Corning Incorporated, Corning, N.Y. 14831), both the porous Vycor® glass and densified Vycor®, low purity silica, such as those made by sintering natural quartz power, high purity fused silica material such as HPFS® glasses made by Corning Incorporated, Corning, N.Y. (Corning glass code 7980™, for example), doped synthetic silica material, such as the low thermal expansion material ULE® made by Corning Incorporated, Corning, N.Y. Suitable glass-ceramic materials that could be laser ablated include, but are not limited to: those comprising β-quartz and/or β-spodumene as the predominant crystalline phase; those comprising cordierite as the predominant crystalline phase; those comprising spinel as the predominant crystalline phase; and the like. One of ordinary skill in the art, in the light of the teachings of the present application, may choose the proper laser source at the proper dosage in order to obtain the desired ablation effect for these differing materials.

As regards organic polymer materials, one of ordinary skill in the art can choose from a list of laser irradiation, by using the proper laser set-up as illustrated infra, to achieve the desired ablation result as well. Typically, the laser ablation of such organic materials would necessarily involve chemical dissociation of the polymer material. In these cases (as in cases involving chemical dissociation of inorganic materials), in order not to cause extensive damages to the area neighboring the exposed area to be ablated, it is desired that ablation lasts for a very short period of time.

Materials transparent in the visible spectrum are highly desired in many applications. Further, such transparency enables ad hoc monitoring of the ablation process by, for example, a camera or other optical detectors from the other side of the substrate opposite to the one being ablated. Transparency of the materials also allows for convenient precision alignment of the article (such as a planar substrate) due to the visibility of the fiduciary marks on the substrates, during the laser ablating process of the present invention or down-stream processing steps or use.

Of course, the material of choice should be desirably inert to the environment or materials to which the article ablated will be exposed to during use. For example, in certain embodiments, the articles are required to have a softening temperature higher than 350° C. because it will be required to be used at a temperature at 350° C. without deformation. For another example, in certain embodiments, the depressions ablated will be used to hold certain high-temperature liquid or solid at a temperature as high as 400° C., sometimes 500° C., sometimes even as high as 800° C. without contaminating the materials held therein. Thus the materials of the article to be ablated should be chemically inert to the materials to be held at those temperatures. For still another example, the depression may be required to have a surface with high affinity to the liquid which it will hold. In another example, the depressions are required to have a surface that has a low affinity to the liquid which it will hold. In many applications, where the article bearing the depressions is to be used repeatedly, it is highly desirable that the materials can withstand the recycling procedure and cleaning conditions.

Typically, due to the thermal expansion of the ablated material, where thermal expansion is involved, transient stress is generated in the area neighboring the exposed area due to the temperature gradient between the exposed area where the depressions are formed and the adjacent non-exposed area. For materials with non-zero thermal expansion (which is the case for most materials), the higher the transient temperature gradient, the higher the transient stress. After the exposure is terminated, the temperature of the exposed area typically would decrease rapidly if the transient temperature gradient is high. This could result in high residual stress in the material in the exposed area and in the adjacent area. Such transient stress and residual stress may not be desired in a number of applications. Moreover, high transient stress and residual stress could lead to breakage of the material if the stresses exceed the level that the material can withstand.

There are two ways to mitigate the transient stress during laser ablation. One is to choose materials with low linear thermal expansion (CTE). The lower the CTE, the lower the stress generated by the same temperature gradient. Therefore, materials with CTE lower than 50×10⁻⁷/K, in certain embodiments preferably lower than 40×10⁻⁷/K, in certain embodiments preferably lower than 30×10⁻⁷/K, in certain other embodiments preferably lower than 15×10⁻⁷/K, in certain other embodiments lower than 10×10⁻⁷/K, in certain other embodiments lower than bout 7.5×10⁻⁷/K, in certain other embodiments lower than 5.0×10⁻⁷/K, in certain other embodiments lower than 3.0×10⁻⁷/K, in certain other embodiments lower than 1.5×10⁻⁷/K, may be desired. Such materials include, but are not limited to: high purity fused silica; Vycor®, densified Vycor®, Kerablack®, Keralite®, Kerawhite® (Kerablack®, Keralite®, Kerawhite® are all produced by Eurokera, France), Zerodur® (Produced by Schott Glass Werke, Germany), Pyrex®, and the like. Another way to mitigate the transient stress is to reduce the temperature gradient. This typically entails heating the material to a temperature sufficiently high before laser ablation to reduce the temperature gradient to a non-detrimental level while maintain the integrity of the material (e.g., heating a glass material to a temperature below its softening point; heating a polymer material to a temperature where it does not dissociate; and the like). These two ways can be complementary. Usually, for materials having a very low CTE, such as silica, the need to reduce the temperature gradient in order to mitigate the stress is less. On the contrary, for materials with relatively high CTE, such as Pyrex®, in certain embodiments one would need to take the measures mentioned above to reduce the temperature gradient in order to prevent cracking when laser ablated.

Reduction of residual stress can be achieved by using low CTE material as well. In addition, residual stress can be reduced by slow cooling of the material or subsequent anneal.

Available laser source for ablating the materials include, but are not limited to: CO₂ laser (10.6 μm), YAG laser (1.06 μm), UV lasers such as those UV excimer lasers (KrF laser at 248 nm, ArF laser at 193 nm, and F₂ laser at 157 nm), and the like. As mentioned supra, high-power laser is typically desired for a short exposure time and for creating certain desired geometry of depressions. CO₂ laser with an output of 40 W is available commercially. Excimer lasers are available at high-power as well. Due to the low cost, high reliability and high output of CO₂ laser, and the absorption of this laser by a number of inorganic glass and glass-ceramic materials, CO₂ laser is the preferred laser source in many applications. The laser beam of a commercial CO₂ laser can be conveniently modulated in terms of pulse length, cycle time, cycle duty and the like, as described infra, in order to suit the needs of creating the desired depressions in the desired material. The YAG laser is typically more expensive than CO₂ laser. However, it could be frequency tripled or quadrupled to 355 nm or 266 nm, at which a number of materials are highly absorptive.

By choosing the appropriate laser source, laser modulation equipment, ablation time, fluence (wattage per unit area) of the laser beam, and the proper material according to the description above, depression with outer diameter in the range of from 1-2000 μm can be made. In certain embodiments, it is preferred that the outer diameter of the depressions are in the range of 1-1000 μm, in certain embodiments from 1 to 500 μm, in certain embodiments from 1 to 300 μm, in certain embodiments from 1 to 200 μm, in certain embodiments from 1 to 100 μm.

It has been found that in certain embodiments, where thermal ablation is involved, the resulting outer diameter of the ablated depression tends to be slightly larger than the diameter of the exposed area. For example, with a CO₂ laser beam having a diameter 30 μm, one can create depressions with outer diameter of 180 μm. Without intending to be bound by any particular theory, the present inventors believe that this is caused by the ablation, melting or flowing of the material adjacent to the exposed area. As mentioned supra, thermal ablation involves heating the ablated area to a very high temperature. Due to heat conduction, the temperature of the material in the neighboring area will inevitably be elevated. Typically, the longer the ablation time, the larger the ratio of the outer diameter of the depression formed to the diameter of the exposed area. This is because more heat would be conducted from the directly exposed area to the neighboring area. Therefore, in order to obtain a relatively smaller outer diameter of the depression, with the same exposure laser beam, it would be desired to shorten the exposure time (ablation time). Another method contemplated for mitigating this heat-conduction effect is to process the same location for multiples ablation operations with sufficient time to cool down the ablated area between each ablation operation. In this way, very deep depressions with a narrow outer diameter can be obtained. Alternatively, it is also possible to scan a small-area laser beam with a relatively low energy density (W·μm⁻²) across a desired area to obtain a depression with an outer diameter larger than the beam diameter.

The depressions with relatively small outer diameter are typically formed by a laser that is essentially stationery relative to the surface of the article on which the depressions are formed. The laser beam may take various shapes, such as circular, rectangle, square, oval, and the like, in order to obtain depressions with desired geometry. However, to simplify the set-up of the laser source, it is often desired that the laser beam is circular. Exposing the laser to a surface normal to a circular laser beam and stationery relative to the laser beam would typically result in a depression with circular cross-sections along the depth direction. In this case, if the laser beam is essentially homogeneous, one should expect to obtain a depression with essentially symmetrical cross-section along the depth direction when cut by planes normal to the depth of the depression. If a circular laser beam impinges on the exposed surface with a certain angle other than 90°, i.e., if the laser beam is not perpendicular to the ablated surface, the exposed area would be no longer circular, and the energy density of the exposure area would differ as well. As a result, a depression having irregular shape and various depth in different locations should be typically expected. In another case, if a circular, essentially homogeneous laser beam impinges on a flat surface vertically, but the exposed surface is allowed to move in a direction perpendicular to the laser beam, the result would be a groove. If the velocity of the ablation surface relative to the laser beam is constant, the groove would be straight. If the ablation surface is allowed to rotate about an axis different from the laser beam but is parallel to the laser, the result of the ablation can be a circle, a semi-circle, or any arc, depending on the time of exposure relative to the revolution cycle. Therefore, one of skill in the art, in the light of the teachings herein, by modulating the velocity of the ablation surface and the laser beam, can obtain depressions with various geometries.

As to depressions with extraordinarily large outer diameter, such as over 2 mm, one of ordinary skill in the art can scan a concentrated laser beam with a significantly smaller diameter in a surface area, thus selectively removing the scanned area in the surface. Thus, it is possible to use the process of the present invention to make articles having a surface bearing depressions having various cross-sectional shapes, such as oval, triangle, rectangle, square, polygonal, and combinations thereof and even more complex shapes.

Therefore, one contemplated use of the process of the present invention is to create aesthetically appealing patterns on article surfaces, such as: engraving of glass bottles, decoration of glass window panes, and the like.

Due to the use of high-energy laser beam, and due to the vaporization of the material of the ablated area, the surface of the ablated area (i.e., the depressions) of the article of certain embodiments of the present invention has fire-polished surface. By “fire-polished surface” is meant that the surface has the features of being heated to a temperature where the viscosity of the material is sufficiently low such that upon cooling it forms a smooth and continuously curvaceous surface due to surface tension. This is especially true of those embodiments involving thermal ablation. As discussed supra, in thermal ablation, the material in the surface area is heated to such a high temperature that the material essentially evaporates. Part of the material in area adjacent to the exposed area would thus melt. When cooling, the melted material would form a fire-polished surface with very low surface roughness. In certain embodiments, the surface roughness of the surface of the depressions is lower than 50 nm, in certain other embodiments lower than 25 nm, in certain other embodiments lower than 10 nm, in certain other embodiments lower than 5 nm, in certain other embodiment lower than 1 nm, in certain other embodiments lower than 0.5 nm, in certain other embodiments lower than 0.3 nm.

Fire-polished surface characterized by lower roughness is advantageous in many applications, especially for those which will be further processed in down-stream steps where surface with low roughness is required or desired, e.g., where additional surface coating layers are to be grown.

To form a plurality of depressions on the surface of an article, a single laser beam may be used repeatedly. Alternatively, a single laser beam could be split into multiple laser beams to enable ablations at multiple locations simultaneously. As illustrated infra, it is also possible that the same laser beam is directed to differing ablating locations at different time alternatively. The use of a single laser beam has the advantage of low cost, and the ease of maintaining a high consistency of the geometry of the ablated depressions. In low-volume production which can be achieved by using a single laser beam, a single beam is particularly advantageous. On the other hand, multiple beams can be advantageously used for high throughput production. However, precision alignment and calibration of the laser beams may be difficult at times in order to achieve high precision alignment of depressions and high consistency of depression geometry.

The process of the present invention is particularly advantageous for forming a plurality of depressions on an article surface which form a depression array. Such micro-cavity arrays are very useful, as mentioned supra, in semiconductor chip-making industry, drug discovery industry and display industry. The depressions (wells) formed on the surface can be further coated with various coatings by, e.g., chemical vapor deposition (CVD), rinsing with a solution, dipping, ion-implantation, and the like. The individual depression may function as a pixel. Multi pixels can combine to form complex patterns. The depressions can serve as micro-scale receptacles for storing and dispensing materials to other applications during manufacturing processes, or can serve as permanent material/information carriers. In many applications, it is desired that the depressions have high consistency in dimensions. It is possible that among the a plurality of depressions formed in the present invention, the standard deviation of outer diameter is not higher than 5 μm, in certain embodiments not higher than 3 μm, in certain embodiments not higher than 1 μm, in certain embodiments not higher than 0.5 μm. It is also possible that among a plurality of depressions formed, the standard deviation of the depth is not larger than 10 μm, in certain embodiments not larger than 5 μm, in certain embodiments not larger than 3 μm, in certain other embodiments not larger than 1 μm. It is possible that among a plurality of depressions, the standard deviation of the outer diameter of is not higher than 10% of the average diameter thereof, in certain embodiments not higher than 8%, in certain other embodiments not higher than 5%, in certain other embodiments not higher than 3%, in certain embodiments not higher than 1%, of the average outer diameter of the depressions. It is also possible that among a plurality of depressions, the standard deviation of the depth is not higher than 10% of the average depth, in certain embodiments not higher than 8%, in certain embodiments not higher than 5%, in certain other embodiments not higher than 3%, in certain other embodiments not higher than 1%, of the average depth of the depressions.

Forming precisely aligned micro-cavity arrays require the precise alignment of the laser beam and the surface on which the depressions are formed. This can be achieved by using precise instruments, fiduciary marks on the surface of the article, and other techniques. Creating an array of depressions by using a single laser source without beam splitting necessitates the movement of the laser beam relative to the surface to be ablated. To obtain precise depression alignment, it is highly desired that the movement between them are precisely controlled. This can be achieved by placing the article to be ablated on a stable stage the motion of which can be precisely controlled while maintaining the laser beam stationery, or vice versa. It has been demonstrated that the process of the present invention can be used to make depression arrays having a standard deviation of the spacing between the rows (or columns) not larger than 10%, in certain embodiments not larger than 8%, in certain other embodiments not larger than 5%, in certain embodiments not larger than 3%, of the average spacing thereof.

One use of such micro-cavity arrays is in printing, where the depressions serve as storage places of dye solutions or other materials. When in use, the surface of the article bearing the depressions holding the dye solution are allowed to contact the surface of an article accepting the dye. If the surface of the recipient article is selectively processed such that certain areas are repellent to the dye solution while other areas are not, the dye would therefore be transferred only to those areas that are not repellent. Those dye pixels combine to form a pattern on the receiving surface. Image printing is thus effected. The presence of the depressions on the surface of dye-supplying article allows for the dispensing of dyes to the recipient surface even if the dye solution is repellent to the surface of the dye-supplying article.

Focusing and delivery of laser beam to the article surface may be effected by means known to one of ordinary skill in the area of optics. Prisms, refractive lenses, reflective mirrors, beam splitters, Galvo lenses, and the like, may be used where necessary to deliver the laser beam with the desired diameter, cycle time, energy, and the like, to the surface of the article to be ablated.

As mentioned supra, for certain applications, the geometry of the depressions are of great importance. Oftentimes, in certain applications, the depressions are required to have an outer diameter not exceeding a certain value as well as a volume of not lower than a certain value. As explained supra, this is sometimes difficult to achieve by isotropic wet etch which is typically used in lithographic process for making the depressions. According to the present invention, by controlling the laser energy and ablation time, one can actually make depressions with various depth, including those having a ratio of outer diameter to depth of lower than 2, in certain embodiments lower than 1.5, in certain embodiments lower than 1.2, in certain embodiments lower than 1.0, in certain embodiments lower than 0.8, in certain embodiments even lower than 0.5. Typically, the higher the energy of the laser per unit area, the more likely it is to create a depression with smaller outer diameter to depth ratio at a fixed exposure time.

As mentioned supra, in certain applications, the cone-shape or truncated-cone shape of depressions is very important. The present inventors have surprisingly found that by employing high-power CO₂ laser ablation, one can obtain an essentially conical and/or essentially truncated-cone shaped depressions by employing a laser beam that is stationery relative to the article surface to be ablated. Without intending to be bound by any particular theory, the present inventors believe this is due to the energy distribution in the laser beam. It is believed that the energy of the laser beam used by the present inventors exhibits a Gaussian distribution across the beam diameter, with the center area having the highest energy. Therefore, the result is: in the center of the exposed area, the depth of the depression is the largest. Also, because the beam energy distribution is largely centrally symmetrical, the depression tends to have circular cross-sections along the depth of the depression if the laser beam is directed to the surface vertically, as discussed supra. The present inventors believe that, if other laser beams are used, as long as the energy distribution of the laser beam is Gaussian, or in a similarly center-high, side-tapering fashion, one should obtain an essentially conical or essentially truncated-conical shaped depression.

It is also to be noted that the process of the present invention may be used for making fiduciary marks according to the teachings above that could be used for precision alignment when the article is used in downstream processes.

Upon formation of the desired depressions on the surface of the article, the article may be subjected to further processing before being used. As mentioned supra, such further processing can include, but are not limited to: (i) formation of organic or inorganic surface coatings, by, e.g., CVD, dip coating, spray coating, brush coating, and the like; (ii) cleaning, such as ultrasonic cleaning, ozone cleaning, plasma cleaning, and the like; (iii) inspection for defects which could, in turn, be repaired by repeating the process of the present invention at the defective area; (iv) etching, to create features that are otherwise difficult or non-economical to create using the process of the present invention; (v) annealing, to reduce stress; (vi) ion implantation; or (vii) ion exchange, etc., to modify the surface chemistry or physical properties of the article.

The present invention is further illustrated by the following non-limiting examples.

### EXAMPLES

In the following examples, a CO₂ laser system capable of producing a defined (frequency, duty cycle, number of pulses) pulse train was used. This laser energy was delivered through a beam delivery system which produced a small (˜30-50 μm outer diameter) spot. The energy density was found to be beyond the threshold for ablation of high purity silica glass, resulting in localized ablation producing a small (less than 100 μm outer diameter of depressions) of controllable depth.

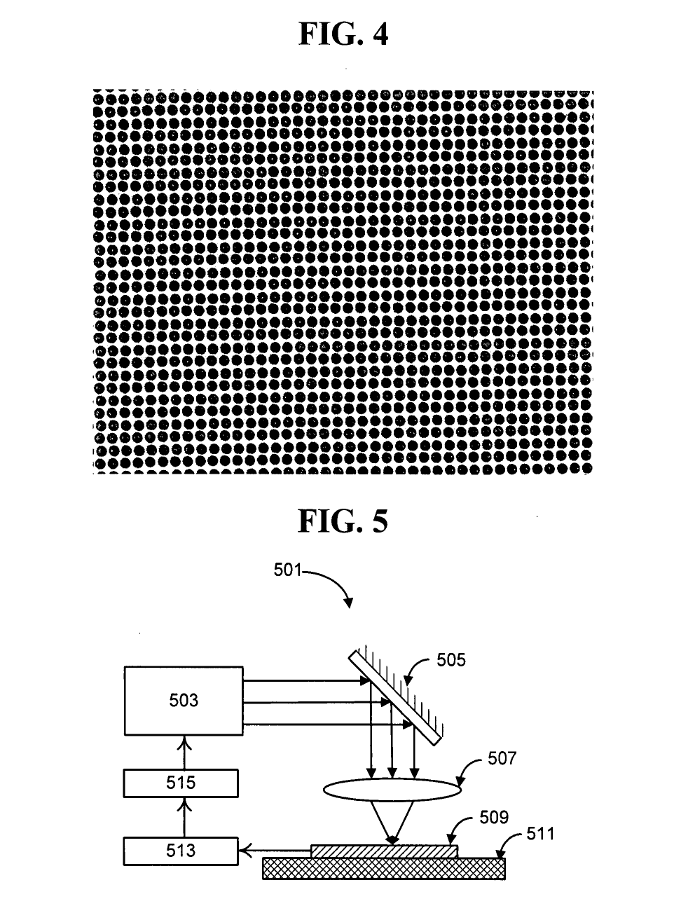

FIG. 4 is a picture of a part of a surface of a silica glass plate laser-ablated by a CO₂ laser beam. The depressions shown on the surface are the dark circles. They have an average outer diameter of 75 μm, and an average spacing between adjacent depressions of 100 μm.

Thermal laser ablation occurs when the energy density is so intense that the material surface temperature exceeds the material vaporization temperature. With glass material this threshold is typically in the 2-100 J/cm² range. To create this energy density in a very small (less than 100 μm) area the laser is highly focused. To be able to control the size and depth of the ablation region both the spot size and total amount of energy was well controlled and repeatable.

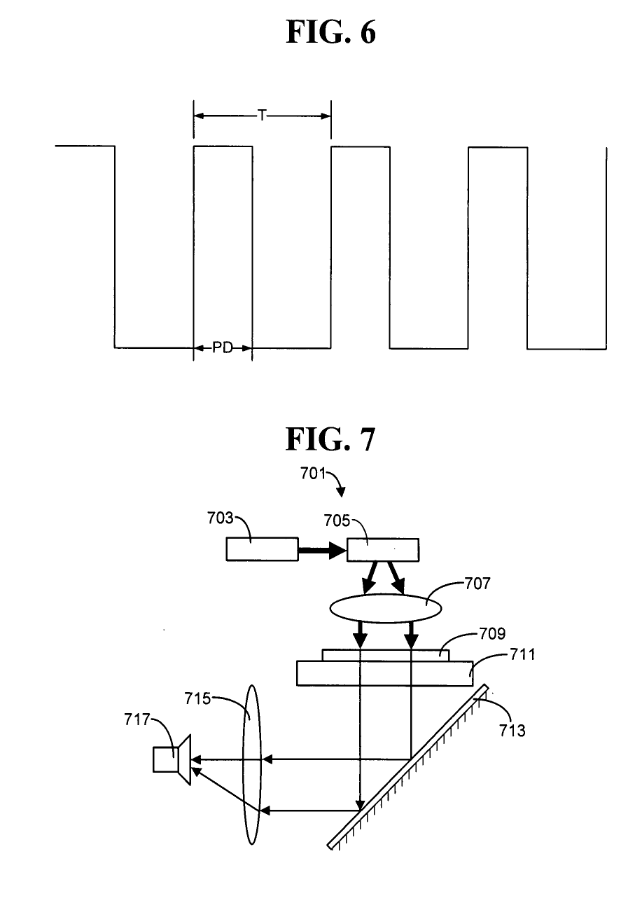

An embodiment of the apparatus of the present invention (501) is depicted in FIG. 5. A CO₂ laser system 503 operated using pulse width modulation (PWM) is used as the primary energy source. The light beam delivered to the target substrate 509 located on a stage 511 with controllable x-y coordinates, via a mirror 505 and a lens 507, is controlled through close regulation of the pulse train. Information of the position of the stage 511 can be fed into a laser control module 515, via a feedback module 513, such that the laser control module 515 can alter the operation parameters of the laser source 503. FIG. 6 schematically illustrates a typical CO₂ laser pulse train. In this figure, T is the cycle length of the exposure cycle, and PD is the pulse length of the laser pulse. In reality, the shape of the pulse train may differ slightly from this figure.

The system is used as a continuous wave (CW) laser source with output power regulated by PWM. The beam leaves the laser and is steered to the target through a series of mirrors and is focused through an aspheric lens to a small (˜30 μm) spot.

The pulse frequency defines the pulse repetition rate, and along with the duty cycle, defines the pulse duration. Hence, the number of pulses, pulse duration, off-time, and repetition rate may be selected (constrained within a range defined by laser manufacturer). These parameters constitute the process control variables influencing ablation rates and material damage.

Pulse Energy Control

A close examination of the range of energy densities possible for a 40 Watt CO₂ laser source with 10-90% duty cycle is given as follows.

Laser CW power=40 W=40 J/s

| PWM | Frequency Period |
|---|---|
| 5 kHz or | T = 200 μs |
| 10 kHz or | T = 100 μs |
| 20 kHz or | T = 50 μs |
| 25 kHz or | T = 40 μs |

Thus the range of pulse durations available is:

10% @ 25 kHz=4 μs*40 J/s=0.160 mJ/pulse

90% @ 5 kHz=180 μs*40 J/s=7.200 mJ/pulse

Where the achieved spot size is on the order of 30 μm (OD), a range of energy densities is obtained from:

Energy Density=Energy/Area

Where:

Area=π·(d²)/4=0.706×10³ μm²=0.706×10⁻³ mm²=7.06×10⁻⁶ cm²

Thus, assuming steady power output (40 W) of the laser source during the pulses, the energy density range is approximately:

From 10% @ 25 kHz: 4 μs×40 J/s=0.160 mJ/pulse=22.7 J·cm⁻²·pulse⁻¹;

To 90% @ 5 kHz: 180 μs×40 J/s=7.200 mJ/pulse=101.8 J·cm⁻².

As indicated the threshold for thermal ablation of glass based materials using a low power CO₂ based laser system may be exceeded by selection of the laser CW power, pulse duration, and beam spot size.

Motion Control

A fixed beam delivery system was used. This system moved the substrate to a desired position, fired the laser a predetermined number of pulses (parameters described above), re-positioned the substrate (stopping at the desired position), and repeated the procedure. With this system we were able to evaluate the process parameters and substrates interactions to optimize the process. This system demonstrated the capability to achieve 20,000 cavities/hour. At this speed a total of 1,000,000 cavities would require on the order of 50 hours to complete.

An alternative would be to move the stage/substrate continuously and fire the laser at pre-determined positions. FIG. 5 depicts an apparatus 501 according to this embodiment. Elongation of the cavity limits the practical velocity at which the substrate may be moved.

In such a system a total of 1,000,000 depressions is estimated to require ˜3 hours to create.

Galvo Options

To increase the speed of the process it is possible to replace the fixed beam delivery system with a galvo based beam delivery system. FIG. 7 schematically shows an apparatus according to this embodiment. In this figure, 703 represents a CO₂ laser source, 705 is a 2-axis galvo lens, 707 is an F-Theta lens, 709 is the substrate to be exposed and ablated, 711 is a stage with controllable x-y coordinates, 713 is a mirror, 715 is another lens, and 717 is a camera system for observing and recording the position of the stage and the substrate.

In this configuration the beam is input into a 2 axis mirror system (galvo) and directed into an F-Theta lensing system which maintains a planar focal distribution. In such a system a total of 1,000,000 cavities expected to take ˜45 minutes to create.

A camera system 715 and 717 is included to provide a fixed observational coordinate system. Using the camera system the galvo coordinate system is mapped onto the image coordinate system. This provides both a quality check and also a calibration mechanism.

Another galvo based configuration uses a dynamic focusing module (DFM) to compensate for variations in the optical path length of the laser beam as it moves a plane.

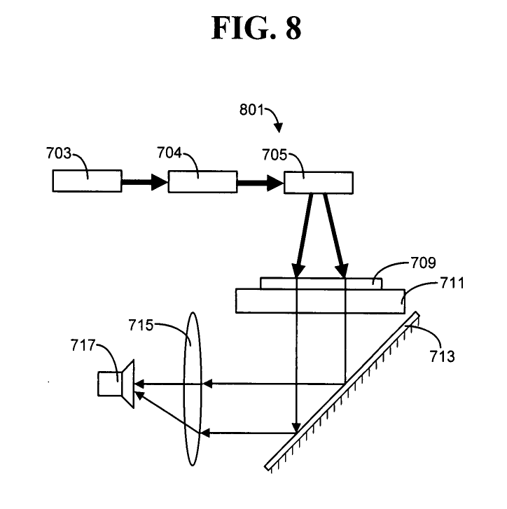

Such a system is depicted in FIG. 8, wherein 704 represents a dynamic focusing module. This DFM module allows the omission of a F-Theta lens.

A camera system can be similarly included to provide a fixed observational coordinate system.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

What is claimed is:

1. An article having a surface bearing a plurality of depressions having an outer diameter of not larger than 500 μm and an outer diameter to depth ratio smaller than 2.

2. An article according to claim 1, wherein the depressions have fire-polished surface.

3. An article according to claim 1, wherein the diameter of each individual depression essentially normal to the direction of the depth thereof decreases in the direction of the depth from the article surface to the bottom of the depression.

4. An article according to claim 1 wherein the depressions have a surface roughness of less than 5 nm.

5. An article according to claim 1 wherein the depressions are formed by directing a laser beam to an area where a depression is desired.

6. An article according to claim 1 wherein the depressions have a standard deviation of outer diameter not higher than 5 μm.

7. An article according to claim 1, at least the surface region of which is made of a material having a coefficient of thermal expansion from 0 to 300° C. in the range of 0-40×10⁻⁷/° C.

8. An article according to claim 1, which is made of silica glass or a glass consisting essentially of silica.

9. An article having a surface bearing a plurality of depressions having an outer diameter of not larger than 500 μm, wherein the depressions have fire-polished surface.

10. An article according to claim 10, wherein the depressions are formed by laser ablation.

11. An article according to claim 10, wherein the depressions have a surface roughness of less than 5 nm.

12. A process for making an article having a surface bearing a plurality of depressions, comprising the following steps:
(A) directing a laser beam to the surface area where the a depression is desired; and
(B) allowing the laser beam to ablate the material in surface area which is exposed to the laser beam, such that a plurality of depressions having an outer diameter not larger than 500 μm is formed.

13. A process according to claim 12, wherein the depressions formed in step (B) have fire-polished surface.

14. A process according to claim 12, wherein in step (B), the time of ablation is sufficiently long such that at least part of the depressions formed have an outer diameter to depth ratio of lower than 2.

15. A process according to claim 12, wherein the depressions formed in step (B) have a surface roughness of less than 5 nm.

16. A process according to claim 12, wherein the surface to be ablated of the article is made of a material having a melting point of not lower than 500° C.

17. A process according to claim 12, wherein at least the surface region of the article to be ablated is made of a material having a coefficient of thermal expansion from 0 to 300° C. in the range of 0-40×10⁻⁷/° C.

18. A process according to claim 16, wherein the article is made of silica or a glass consisting essentially of silica.

19. A process according to claim 12, wherein the laser is selected from the group consisting of: CO₂ laser, YAG laser, UV excimer laser.

20. A process according to claim 12, wherein the surface area directly exposed to the laser beam has a diameter of less than 150 μm.

21. A process according to claim 12, wherein the laser beam has a Gaussian distribution of energy across the beam area.
